(19) United States
(12) Patent Application Publication
(10) Pub. No.: US 2025/0326675 A1
(43) Pub. Date: Oct. 23, 2025

(54) MOLD AND METHOD FOR FABRICATING LENS

(71) Applicant: AAC Optics (Chongqing) Co., Ltd., Chongqing (CN)

(72) Inventors: Linzhi Zhao, Chongqing (CN); Jian Wang, Chongqing (CN)

(21) Appl. No.: 18/666,867

(22) Filed: May 17, 2024

Related U.S. Application Data
(63) Continuation of application No. PCT/CN2024/089408, filed on Apr. 23, 2024.

(51) Int. Cl. C03B 23/03

(52) U.S. Cl. CPC C03B 23/0302; C03B 2215/412; C03B 2215/414

(57) ABSTRACT

A mold and a method for fabricating a lens are provided, for shaping the lens. The mold includes a first mold and a second mold matching the first mold. The first mold includes a first mold body, multiple first molding parts with an arc-shaped surface formed by a side of the first mold body close to the second mold, annular second molding parts respectively formed by outer peripherals of the first molding part and annular first balancing rings formed by outer peripherals of the second molding parts. The second mold includes a second mold body, multiple annular third molding parts formed on a side of the second mold body close to the first mold, annular fourth molding parts respectively formed around the outer peripherals of the third molding parts and annular second balancing rings formed by the outer peripherals of the fourth molding parts.

### CROSS REFERENCE TO RELATED APPLICATIONS

The present application a continuation of PCT Patent Application No. PCT/CN2024/089408 entitled “MOLD AND METHOD FOR FABRICATING LENS,” filed Apr. 23, 2024, which is incorporated by reference herein in its entirety.

### TECHNICAL FIELD

Embodiments of the present disclosure relate to the field of mold technologies, and in particular to a mold and a method for fabricating a lens.

### BACKGROUND

Lenses are generally fabricated as follows. A sheet material is placed on a surface of a lower mold. An upper mold fits on the lower mold to extrude the sheet material. A formed lenses are cut into individual lenses as required or applied directly.

Molds in related technologies each include an upper mold and a lower mold. The upper mold is provided with multiple upper formation parts. The lower mold is provided with multiple lower formation parts. A respective upper formation part of the multiple upper formation parts and a lower molding part corresponding to the respective upper formation part form a mold cavity. The respective upper formation part is provided with a recessed part and a flat part away from the recessed part, and the corresponding lower molding part is provided with a convex part and a flat part away from the convex part. The upper and lower molds come together to extrude the sheet material to form the lens. However, the multiple upper molding parts and the multiple lower molding parts are arranged in an array. As a result, after the multiple upper molding parts fit on the corresponding lower molding parts, the pressure at the center and the edge of the mold is uneven. Therefore, the lens formed in the inner mold cavity is significantly different form that formed in the outer mold cavity, and lenses formed in some cavities have poor appearances.

In view of this, it is desired to provide a novel mold that can resolve the previously stated technical problem.

### SUMMARY

The present disclosure is intended to provide a mold with consistent lens molding pressure, high production efficiency, and high-quality molded products.

In order to achieve the above purpose, in a first aspect, a mold is provided according to some embodiments of the present disclosure. The mold is applied for compression molding of lens. The mold includes a first mold and a second mold matching the first mold. The first mold includes a first mold body, multiple first molding parts with an arc-shaped surface formed by a side of the first mold body close to the second mold, second molding parts each in ring-shaped and formed by outer peripherals of a corresponding first molding part and first balancing rings each in ring-shaped and formed by outer peripherals of a corresponding second molding parts. Each second molding part surrounds the corresponding first molding part, and each first balance ring surrounds the corresponding second molding part. The first balance ring is configured to facilitate an inclined transition between the outer peripheral edge of the second molding part and the side of the first mold body close to the second mold. The second mold includes a second mold body, multiple third molding parts each in ring-shaped and formed on a side of the second mold body close to the first mold, fourth molding parts each in ring-shaped and formed around the outer peripherals of the third molding parts and second balancing rings each in ring-shaped and formed by the outer peripherals of the fourth molding parts. The second balance ring is configured to facilitate a transition between the outer peripheral edge of the fourth molding part and the side of the second mold body close to the first mold. The first mold body and the second mold body are arranged correspondingly, the first molding part and the third molding part correspond to each other and are spaced apart to form a first gap, and the first gap is configured to form an optical part of the lens. The second molded part and the fourth molded part correspond to each other and are spaced apart to form a second gap, and the second gap is configured to form a structural part of the lens. The first balancing ring and the second balancing ring correspond to each other and are spaced apart to form a third gap, and the third gap is configured to form an auxiliary part of the lens.

As an improvement, the multiple first molding parts are arranged in an array and the multiple third molding parts are arranged in an array.

As an improvement, the first gap has a thickness gradually increasing from its center toward a direction approaching the second gap, and the third gap has a thickness gradually decreasing from a side close to the second gap to a direction away from the second gap.

As an improvement, a central thickness of the optical part gradually increases along a thickness of its outer edge; a thickness of an inner edge of the structural part is equal to a thickness of an outer edge of the optical part; a thickness of the inner edge of the structural part gradually decreases along a direction of its outer edge; and a thickness of the auxiliary part gradually decreases from a thickness close to an outer edge of the structural part to a thickness away from the outer edge of the structural part.

As an improvement, the first molding part is formed by a protrusion from a side of the first mold body close to the second mold body, the second molding part is formed by a depression on a side of the first mold body close to the second mold body, and the first balancing ring is formed by a recess on one side of the first mold body close to the second mold body. The third molding part is formed by a side of the second mold body close to the first mold body that is recessed inwards, the fourth molding part is formed by a side of the second mold body close to the second mold body that is recessed inwards, and the second balance ring is formed by a depression on a side of the second mold body close to the first mold body. A depth of the depression of the third molding part is smaller than a depth of the depression of the fourth molding part.

As an improvement, the first gap has a thickness gradually decreasing from its center in a direction approaching the second gap, the third gap has a thickness gradually increasing from the side close to the second gap to the side away from the second gap, and the thickness of the third gap is smaller than the thickness of the first gap.

As an improvement, a central thickness of the optical part gradually decreases along its outer edge, a thickness of the inner edge of the structural part is equal to the thickness of the outer edge of the optical part, a thickness of the inner edge of the structural part gradually increases along the direction of its outer edge, and a thickness of the auxiliary part gradually increases from the thickness close to the outer edge of the structural part to the thickness away from the outer edge of the structural part.

As an improvement, the first molding part is formed by a depression on one side of the first mold body close to the second mold body, the second molding part is formed by a protrusion of the first mold body close to the second mold body, and the first balancing ring is formed by a recess on one side of the first mold body close to the second mold body. The third molding part is formed by a recess on a side of the second mold body close to the first mold body, the fourth molding part is formed by a recess on a side of the second mold body close to the second mold body, and the second balancing ring extends horizontally from the side of the second mold body close to the first mold body.

As an improvement, a thickness of the first gap is equal to the thickness of the second gap, and a thickness of the third gap gradually decreases from a side close to the second gap to a side away from the second gap.

As an improvement, a central thickness of the optical part is consistent with a thickness of its outer edge; a thickness of the inner edge of the structural part is equal to a thickness of the outer edge of the optical part, a thickness of the inner edge of the structural part gradually increases along a direction of its outer edge, and a thickness of the auxiliary part gradually decreases from a thickness close to the outer edge of the structural part to a thickness away from the outer edge of the structural part.

As an improvement, the first molding part is formed by a protrusion from a side of the first mold body close to the second mold body, the second molding part is formed by a side of the first mold body close to the second mold body being recessed inwards, and the first balancing ring protrudes from a side of the first mold body close to the second mold body. The third molding part is formed by a recess on a side of the second mold body close to the first mold body, the fourth molding part is formed by a recess on a side of the second mold body close to the second mold body, and the second balancing ring is formed by a recess on a side of the second mold body close to the first mold body.

As an improvement, the first balancing ring and the second balancing ring are configured to jointly realize overflow or flow obstruction.

In a second aspect, a method for fabricating a lens is provided according to some embodiments of the present disclosure. The method is implemented based on the mold as described above. The method includes:
S1. providing a sheet material to be processed;
S2. stacking the sheet material on an upper surface of the second mold;
S3. heating the second mold to soften the sheet material;
S4. fitting the first mold, corresponding to the second mold, on the sheet material;
S5. extruding the first mold according to a preset pressure to form a lens blank; and
S6. cutting off the lens blank formed in a portion corresponding to the third gap to obtain the finished lens.

Compared with the existing mold, in the mold of some embodiments of the present disclosure, the first mold includes a first mold body, multiple first molding parts with an arc-shaped surface formed by a side of the first mold body close to the second mold, second molding parts each in ring-shaped and formed by outer peripherals of a corresponding first molding part and first balancing rings each in ring-shaped and formed by outer peripherals of the second molding parts; the second molding part surrounds the corresponding first molding part; and the first balance ring surrounds the corresponding second molding part, and the first balance ring is configured to facilitate an inclined transition between the outer peripheral edge of the second molding part and the side of the first mold body close to the second mold. The second mold includes a second mold body, multiple annular third molding parts formed on a side of the second mold body close to the first mold, fourth molding parts each in ring-shaped and formed around the outer peripherals of the third molding parts and second balancing rings each in ring-shaped and formed by the outer peripherals of the fourth molding parts; and the second balance ring is configured to facilitate a transition between the outer peripheral edge of the fourth molding part and the side of the second mold body close to the first mold. The first mold body and the second mold body are arranged correspondingly. A first balance ring and a second balance ring are respectively provided on the outer peripheral sides of the second molding part and the fourth molding part. The first balance ring and the second balance ring is configured to facilitate the adjustment of the molding pressure at the positions of the first gap and the second gap. This adjusts the consistency of cavity molding in the inner and outer circles, thereby shortening the molding cycle.

### BRIEF DESCRIPTION OF THE DRAWINGS

In order to explain the technical solutions in the embodiments of the present disclosure more clearly, the drawings to be used in the description of the embodiments will be briefly introduced below. Obviously, the drawings in the following description are only some embodiments of the present disclosure. For those of ordinary skill in the art, other drawings can also be obtained based on these drawings without exerting creative efforts. In the drawings:

FIG. 1 is a schematic three-dimensional structural diagram of the mold provided in a first embodiment of the present disclosure.

FIG. 2 is a cross-sectional view along a line A-A in FIG. 1.

FIG. 3 is an enlarged view of part B of FIG. 2.

FIG. 4 is a diagram of the mold in use using the mold provided in a second embodiment of the present disclosure.

FIG. 5 is a diagram of the separate use state of the mold provided in the second embodiment of the present disclosure.

FIG. 6 is a schematic three-dimensional structural diagram of the mold provided in a third embodiment of the present disclosure.

FIG. 7 is a cross-sectional view along a line C-C of FIG. 6.

FIG. 8 is a partial enlarged view of D in FIG. 7.

FIG. 9 is a schematic three-dimensional structural diagram of the mold provided in a fourth embodiment of the present disclosure.

FIG. 10 is a cross-sectional view along a line E-E of FIG. 9.

FIG. 11 is an enlarged view of part F of FIG. 10.

FIG. 12 is a flow chart of a method for fabricating a lens provided in an embodiment of the present disclosure.

In the drawings:

100: mold; 1: first mold; 11: first mold body; 12: first molding part; 13: second molding part; 14: first balancing ring; 2: second mold; 21: second mold body; 22: third molding part; 23: Fourth molding part; 24: second balance ring; 3: first gap; 4: second gap; 5: third gap; 20: lens.

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are only some rather than all of the embodiments of the present disclosure. Based on the embodiments in this application, all other embodiments obtained by those of ordinary skill in the art without creative efforts fall within the scope of protection of this application.

### First Embodiment

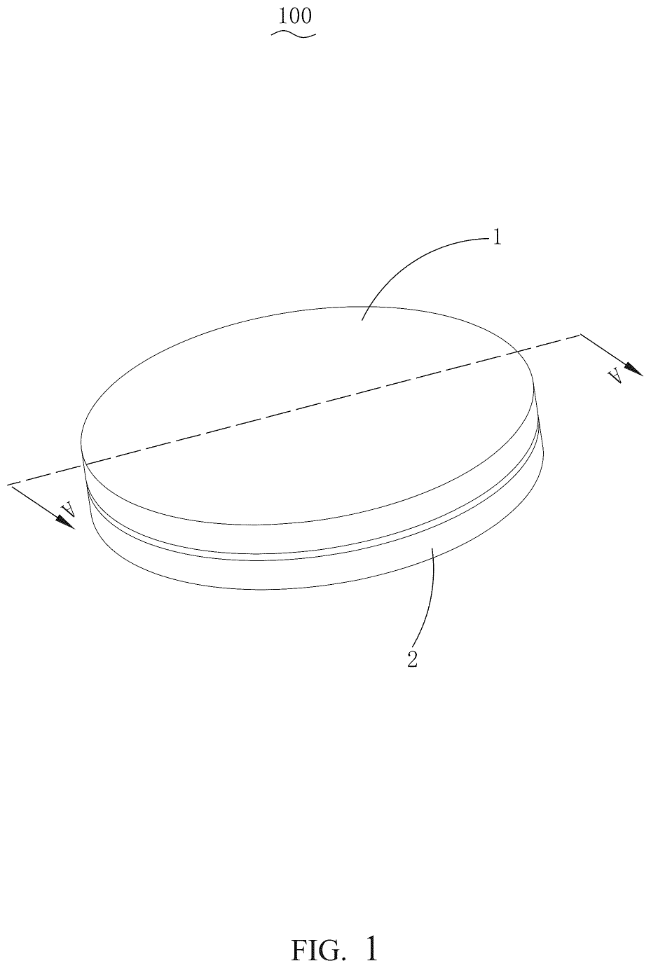

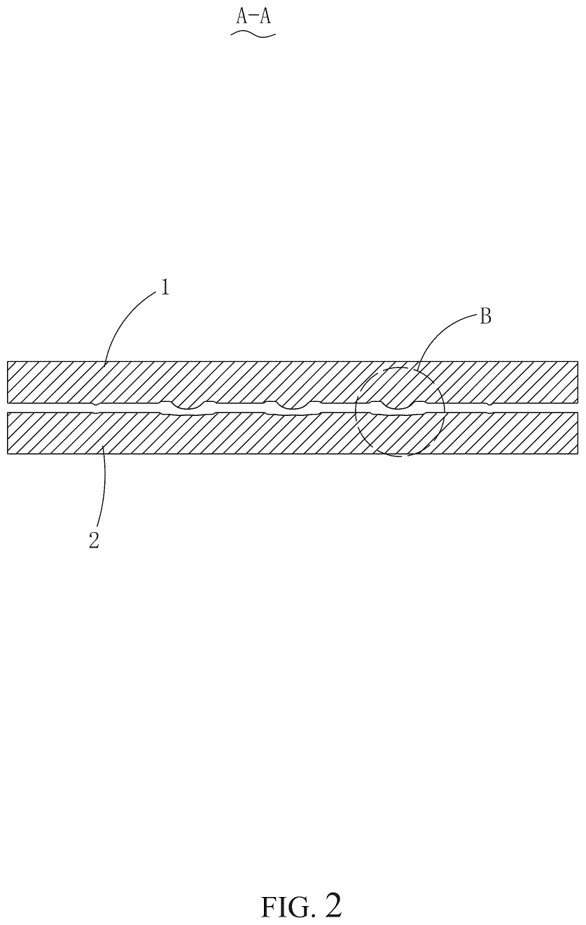

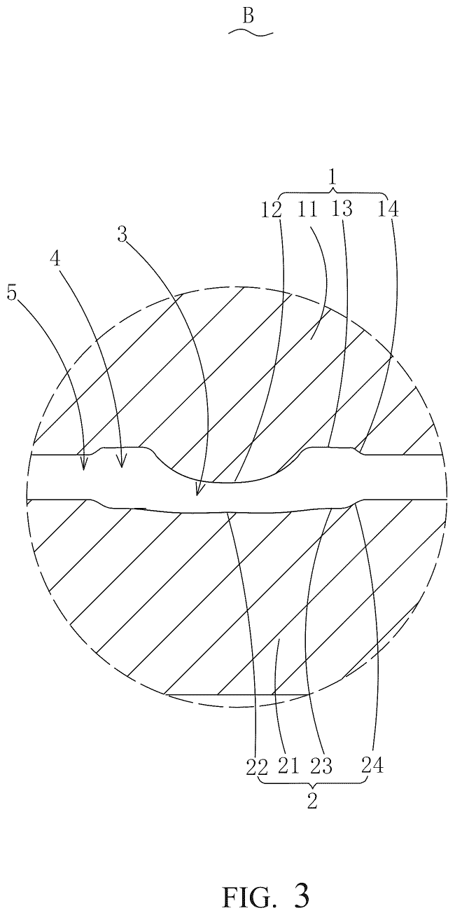

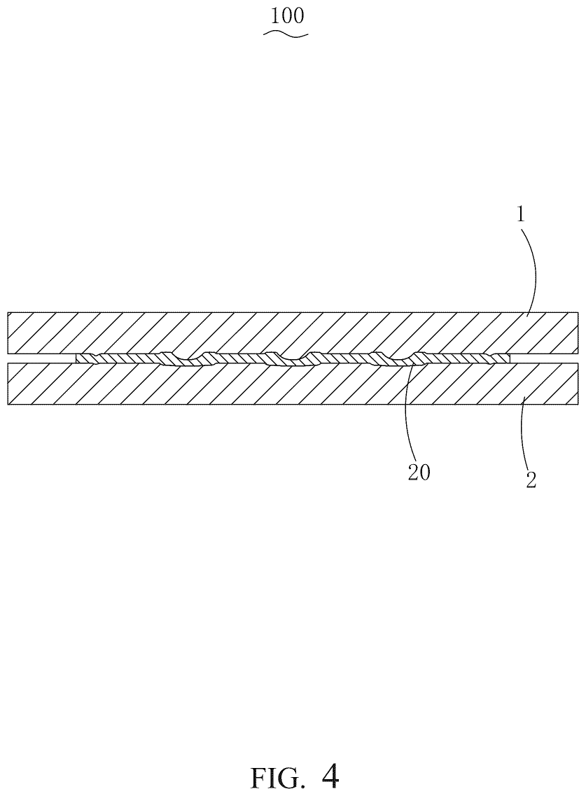

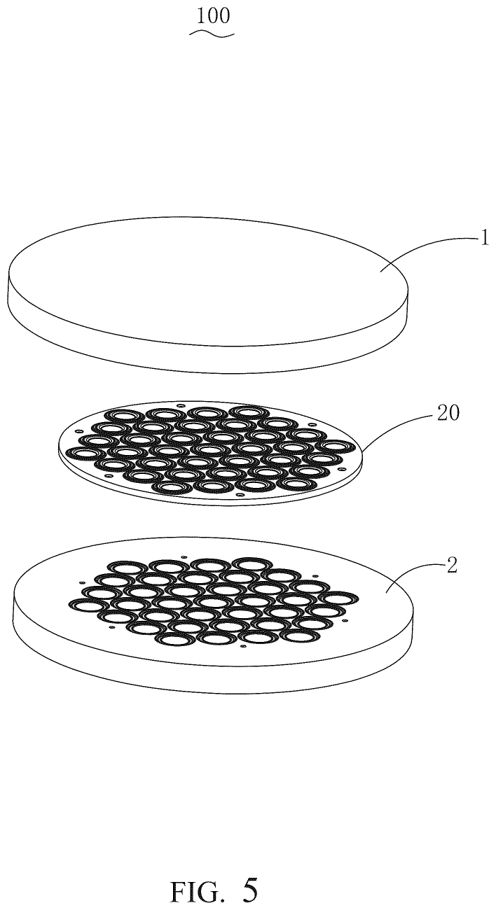

As shown in FIGS. 1 to 5, an embodiment of the present disclosure provides a mold 100. The mold 100 is applied for compression molding of the lens 20. The mold 100 includes a first mold 1 and a second mold 2 matching the first mold 1. The first mold 1 is the upper mold. The second mold 2 is the lower mold. The sheet material is placed on the upper surface of the second mold 2. The first mold 1 fits on the second mold 2 to squeeze the sheet material. By applying a preset pressure to shape the sheet material as required, the required lens 20 is obtained.

The first mold 1 includes a first mold body 11, multiple first molding parts 12 with an arc-shaped surface formed by a side of the first mold body 11 close to the second mold 2, annular second molding parts 13 respectively formed by outer peripherals of the first molding part 12 and annular first balancing rings 14 respectively formed by outer peripherals of the second molding parts 13. The second molding part 13 surrounds the corresponding first molding part 12. The first balancing ring 14 surrounds the corresponding second molding part 13. The first balancing ring 14 is configured to realize an inclined transition between the outer peripheral edge of the second molding part 13 and the side of the first mold body 11 close to the second mold 2. The second mold 2 includes a second mold body 21, multiple annular third molding parts 23 formed on a side of the second mold body 21 close to the first mold 1, annular fourth molding parts 23 respectively formed around the outer peripherals of the third molding parts 22 and annular second balancing rings 24 respectively formed by the outer peripherals of the fourth molding parts 23. The second balance ring 24 is configured to facilitate a transition between the outer peripheral edge of the fourth molding part 23 and the side of the second mold body 21 close to the first mold 1.

In this embodiment, the first molding part 12, the second molding part 13, the third molding part 22, the fourth molding part 23, the first balancing ring 14 and the second balancing ring 24 are all circular.

The first mold body 11 and the second mold body 21 are arranged correspondingly. The first molding part 12 and the third molding part 22 correspond to each other and are spaced apart to form a first gap 3. The optical part of the lens is located in the first gap 3. The second molding part 13 and the fourth molding part 23 correspond to each other and are spaced apart to form a second gap 4. The structural part of the lens is located in the second gap 4. The first balancing ring 14 and the second balancing ring 24 correspond to each other and are spaced apart to form a third gap 5. The auxiliary part of the lens is located in the third gap 5. The first balancing ring 14 and the second balancing ring 24 are provided on the outer peripheral sides of the second molding part 13 and the fourth molding part 23 respectively. The first balance ring 14 and the second balance ring 24 facilitate the adjustment of the molding pressure at the positions of the first gap 3 and the second gap 4, thereby adjusting the consistency of the cavity molding of the inner and outer rings, thereby shortening the molding cycle.

Through different structural settings of the first gap 3, the second gap 4 and the third gap 5, a variety of different lens structures for example, a concave lens or a convex lens, can be obtained.

In this embodiment, the first molding parts 12 are arranged in an array, and the third molding parts 22 are arranged in an array. The lens 20 is molded in large quantities and therefore the production efficiency is high.

In this embodiment, the structures of the first balancing ring 14 and the second balancing ring 24 can be the same or differentiated, so that the internal and external molding pressure and molding time can be adjusted more accurately.

### Second Embodiment

As shown in FIGS. 1 to 5, based on the first embodiment, in this embodiment, the thickness of the first gap 3 gradually increases from its center to the direction close to the second gap 4. The thickness of the third gap 5 gradually decreases from the side close to the second gap 4 to the direction away from the second gap 4. The sheet material is molded by the first mold 1 and the second mold 2 so that the sheet material is extruded into the first gap 3, the second gap 4 and the third gap 5. The thickness of the center of the first gap 3 gradually increases along the side close to the second gap 4, and therefore the lens 20 forms a hat-shaped lens with a thin center and a thick edge. The balance ring structure formed by the third gap 5 is added to the edge of the lens 20, the molding pressure at the outer ring cavity can be significantly increased and therefore the molding time of the outer ring cavity can be shortened.

In this embodiment, the central thickness of the optical part gradually increases along the outer edge thereof. The thickness of the inner edge of the structural part is equal to the thickness of the outer edge of the optical part. The thickness of the inner edge of the structural part gradually decreases along the direction of its outer edge. The thickness of the auxiliary part gradually decreases from the thickness close to the outer edge of the structural part to the thickness away from the outer edge of the structural part.

In this embodiment, the plane facing the outer periphery of the first mold 1 and the second mold 2 is a reference plane. The first molding part 12 is formed by a protrusion from a side of the first mold body 11 close to the second mold body 21. The second molding part 13 is formed by a side of the first mold body 11 close to the second mold body 21 that is recessed inward. The first balancing ring 14 is formed by a recess on the side of the first mold body 11 close to the second mold body 21. The third molding part 22 is formed by a side of the second mold body 21 close to the first mold body 11 that is recessed inward. The fourth molding part 23 is formed by a side of the second mold body 21 close to the second mold body 21 that is recessed inward. The second balancing ring 24 is formed by a recess on the side of the second mold body 21 close to the first mold body 11. The recessed depth of the third formed part 22 is smaller than the recessed depth of the fourth formed part 23. It is easy to mold to form a concave mirror with a thin center and thick edges. By disposing the first balancing ring 14 and the second balancing ring 24 at the closing position, the molding pressure of the outer ring cavity can be significantly increased and the molding time of the outer ring cavity can be shortened.

Optionally, the first molding part 12 may also be formed in a concave manner. The third molding part 22 may be formed as a protrusion. The thickness of the center of the first gap 3 along the side close to the second gap 4 gradually increases, forming a lens structure with a thin center and a thick edge. One or both of first balancing ring 14 and the second balancing ring 24 may be formed by a recess, as long as the connection position between the second gap 4 and the first gap 3 forms an enclosed structure.

### Third Embodiment

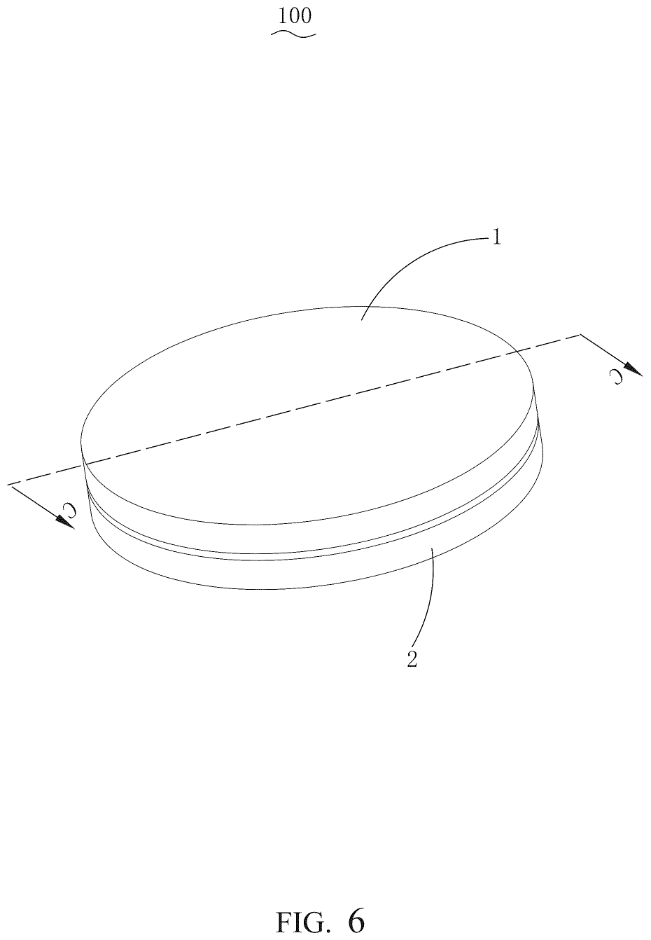

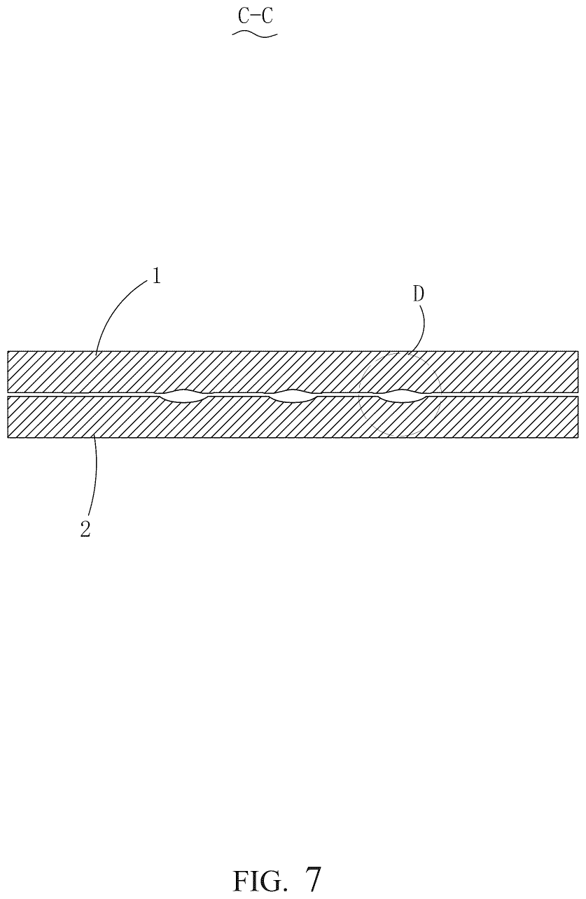

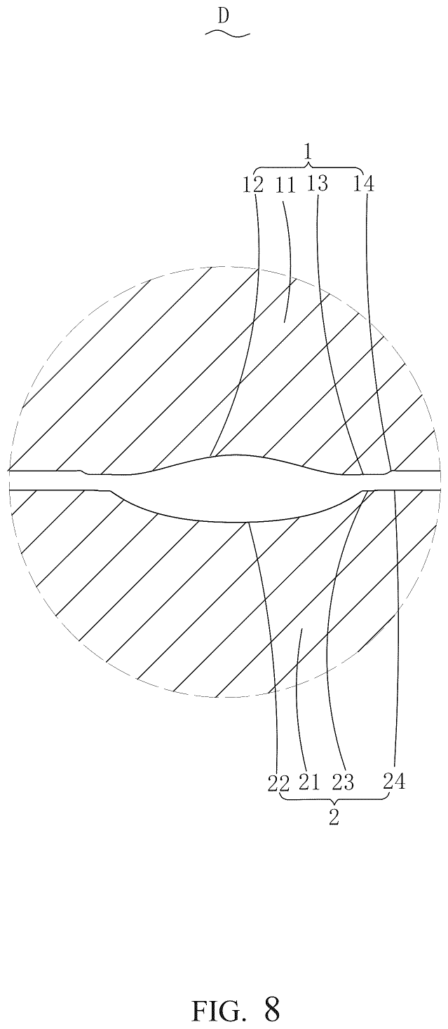

As shown in FIGS. 6 to 8, based on the first embodiment, in this embodiment, the thickness of the first gap 3 gradually decreases from its center in the direction approaching the second gap 4. The thickness of the third gap 5 gradually increases from the side close to the second gap 4 to the side away from the second gap 4. The thickness of the third gap 5 is smaller than the thickness of the first gap 3. The sheet material is molded by the first mold 1 and the second mold 2 so that the sheet material is extruded into the first gap 3, the second gap 4 and the third gap 5 for subsequent fi. The thickness of the center of the first gap 3 gradually decreases along the side close to the second gap 4, so that the lens 20 forms a lens structure with a thick center and thin edges. Adding the balance ring structure formed by the third gap 5 to the edge of the lens 20 can significantly increase the molding pressure of the inner ring cavity and shorten the molding time of the inner ring cavity.

In this embodiment, the central thickness of the optical part gradually decreases along the outer edge thereof. The thickness of the inner edge of the structural part is the same as the thickness of the outer edge of the optical part. The thickness of the inner edge of the structural part gradually increases along the direction of its outer edge. The thickness of the auxiliary part gradually increases from the thickness close to the outer edge of the structural part to the thickness away from the outer edge of the structural part.

In this embodiment, the first molding part 12 is formed by a recess on the side of the first mold body 11 close to the second mold body 21. The second molding part 13 is formed by a protrusion of the first mold body 11 close to the second mold body 21. The first balancing ring 14 is formed by a recess on the side of the first mold body 11 close to the second mold body 21. The third molding part 22 is formed by a recess on the side of the second mold body 21 close to the first mold body 11. The fourth molding part 23 is formed by a recess on a side of the second mold body 21 close to the second mold body 21. The second balancing ring 24 extends horizontally from a side of the second mold body 21 close to the first mold body 11. It is easy to mold to form a convex mirror with a thick center and thin edges. The first balance ring 14 and the second balance ring 24 are arranged at the opening position, which can significantly increase the molding pressure of the inner circle cavity and shorten the molding time of the outer circle cavity.

Optionally, one or both of the first balancing ring 14 and the second balancing ring 24 may be recessed, as long as the connection position between the second gap 4 and the first gap 3 forms an open structure.

### Fourth Embodiment

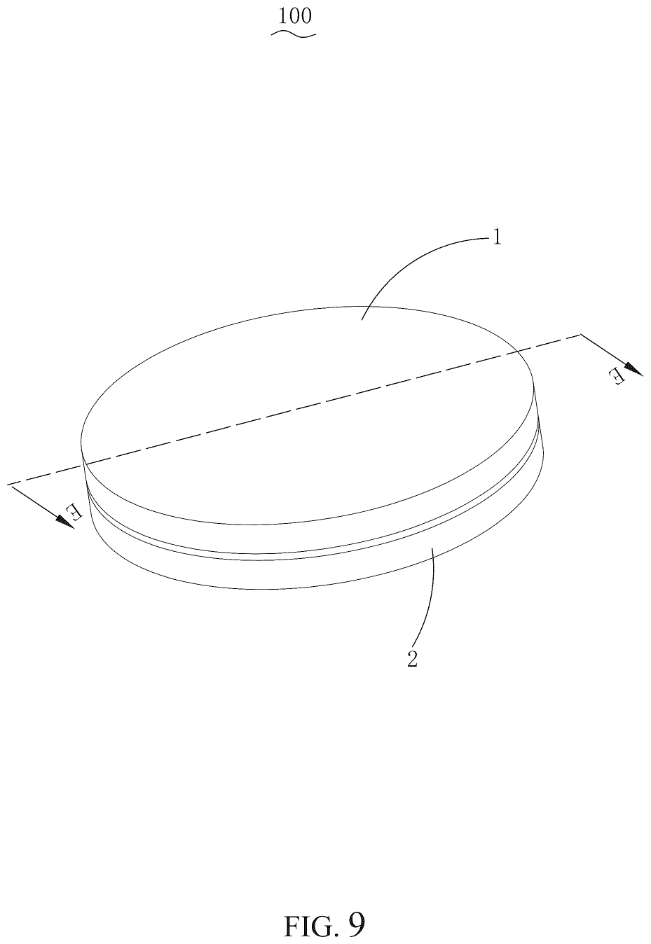

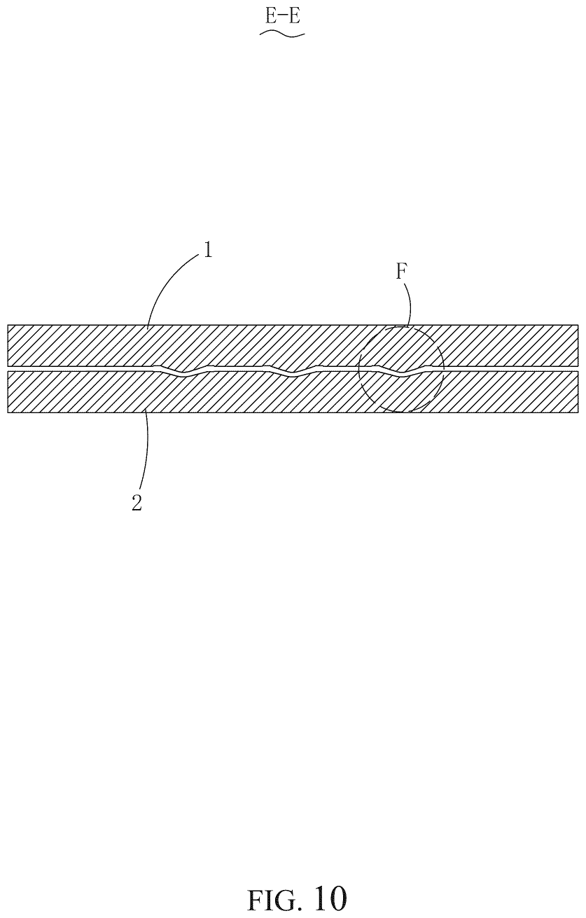

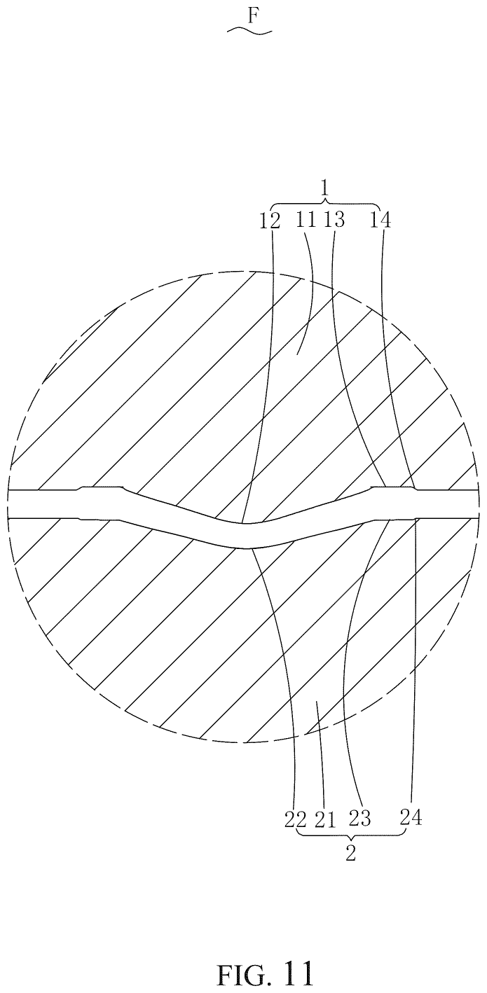

As shown in FIGS. 9 to 11, based on the first embodiment, in this embodiment, the thickness of the first gap 3 is equal to the thickness of the second gap 4. The thickness of the third gap 5 gradually decreases from the side close to the second gap to the side away from the second gap 4. The sheet material is molded by the first mold 1 and the second mold 2 so that the sheet material is extruded into the first gap 3, the second gap 4 and the third gap 5 for subsequent formation. The thickness of the first gap 3 is equal to the thickness of the second gap 4, and therefore the lens 20 forms a structural lens with equal center and edge thicknesses. Adding the balance ring structure formed by the third gap 5 to the edge of the lens 20 can significantly increase the molding pressure of the outer ring acupoints and shorten the molding time of the outer ring acupoints.

In this embodiment, the center thickness of the optical part is consistent with the thickness of its outer edge. The thickness of the inner edge of the structural part is the same as the thickness of the outer edge of the optical part. The thickness of the inner edge of the structural part gradually increases along the direction of its outer edge. The thickness of the auxiliary part gradually decreases from the thickness close to the outer edge of the structural part to the thickness away from the outer edge of the structural part.

In this embodiment, the first molding part 12 is formed by protruding from the side of the first mold body 11 close to the second mold body 21. The second molding part 13 is formed by a side of the first mold body 11 close to the second mold body 21 that is recessed inward. The first balancing ring 14 protrudes from a side of the first mold body 11 close to the second mold body 21. The third molding part 22 is formed by a recess on the side of the second mold body 21 close to the first mold body 11. The fourth molding part 23 is formed by a recess on a side of the second mold body 21 close to the second mold body 21. The second balancing ring 24 is formed by a recess on the side of the second mold body 21 close to the first mold body 11. It is convenient for molding to form a concave mirror with a thin center and thick edges. The first balance ring 14 and the second balance ring 24 are arranged at the closing position, which can significantly increase the molding pressure of the outer ring acupoints and shorten the molding time of the outer ring acupoints.

In this embodiment, the first balancing ring 14 and the second balancing ring 24 jointly realize overflow or flow obstruction.

Compared with the existing mold, in the mold of the present disclosure, the first mold comprises a first mold body, multiple first molding parts with an arc-shaped surface formed by a side of the first mold body close to the second mold, annular second molding parts respectively formed by outer peripherals of the first molding part and annular first balancing rings formed by outer peripherals of the second molding parts; the second molding part surrounds the corresponding first molding part; and the first balance ring surrounds the corresponding second molding part, and the first balance ring facilitates an inclined transition between the outer peripheral edge of the second molding part and the side of the first mold body close to the second mold. The second mold comprises a second mold body, multiple annular third molding parts formed on a side of the second mold body close to the first mold, annular fourth molding parts respectively formed around the outer peripherals of the third molding parts and annular second balancing rings formed by the outer peripherals of the fourth molding parts; and the second balance ring facilitates a transition between the outer peripheral edge of the fourth molding part and the side of the second mold body close to the first mold. The first mold body and the second mold body are arranged correspondingly. A first balance ring and a second balance ring are respectively provided on the outer peripheral sides of the second molding part and the fourth molding part. The first balance ring and the second balance ring facilitate the adjustment of the molding pressure at the positions of the first gap and the second gap. This adjusts the consistency of cavity molding in the inner and outer circles, thereby shortening the molding cycle.

### Fifth Embodiment

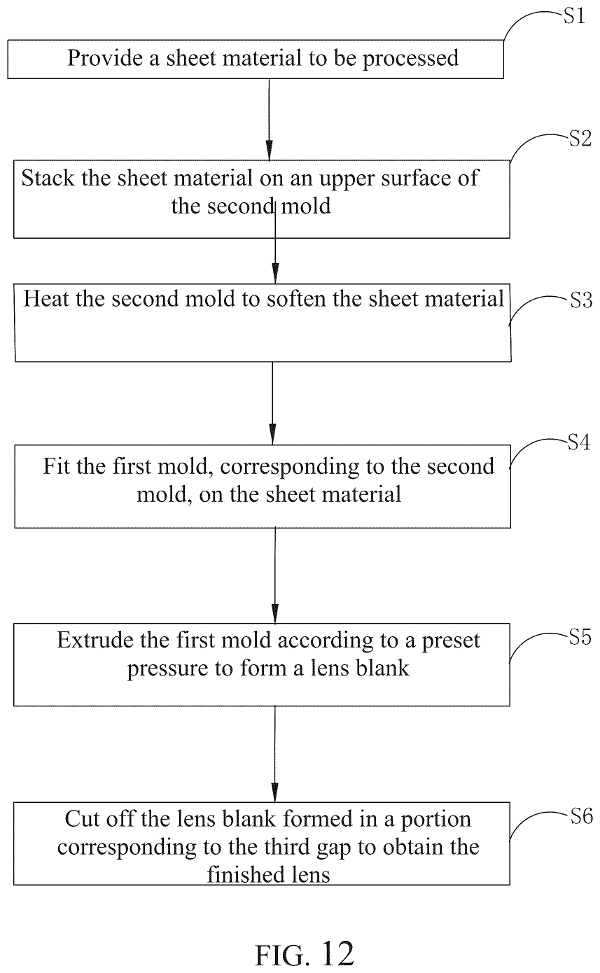

As shown in FIGS. 1 to 12, embodiments of the present disclosure provide a method for fabricating a lens. The method is implemented based on the mold 100 of the above-mentioned first to fourth embodiments.

The method includes the following embodiments.

S1. providing a sheet material to be processed;

where sheet material is optical glass or quartz glass, etc.;

S2. stacking the sheet material on an upper surface of the second mold 2;

S3. heating the second mold 2 to soften the sheet material;

S4. fitting the first mold 1, corresponding to the second mold 2, on the sheet material;

where inner and outer rings of the first balance ring 14 and the second balance ring 24 have the same forming pressure, thereby more accurately adjusting the inner and outer molding pressure and molding time.

S5. extruding the first mold 1 according to a preset pressure to form a lens blank; and

S6. cutting off the lens blank formed in a portion corresponding to a third gap 5 to obtain the finished lens.

The second mold 2 is horizontally fixed on the ground or a workbench. The sheet material is placed on the upper surface of the second mold 2. The heating device heats the second mold 2 to soften the sheet material. The first mold 1 fits on the second mold 2 to extrude the sheet material to form a lens blank. After the lens blank is cooled to room temperature, the laser cutting equipment cuts off the portion of the lens blank formed by the third gap 5 according to predetermined requirements to obtain a finished lens. The molding pressure of the inner and outer rings of the lens is consistent, so the molding pressure and molding time of the inner and outer rings can be adjusted more accurately.

Only embodiments of the present disclosure have described above. It should be noted here that for those of ordinary skill in the art, improvements can be made without departing from the creative concept of the present disclosure, but these all fall within the protection scope of the present disclosure.

What is claimed is:

1. A mold, applied for compression molding of lens, wherein the mold comprises a first mold and a second mold matching the first mold,
the first mold comprises a first mold body, a plurality of first molding parts with an arc-shaped surface formed by a side of the first mold body close to the second mold, second molding parts each in ring-shaped and formed by outer peripherals of the first molding part and first balancing rings each in ring-shaped and formed by outer peripherals of the second molding parts; the second molding part surrounds the corresponding first molding part; and the first balance ring surrounds the corresponding second molding part, and the first balance ring is configured to facilitate an inclined transition between the outer peripheral edge of the second molding part and the side of the first mold body close to the second mold;
the second mold comprises a second mold body, a plurality of annular third molding parts formed on a side of the second mold body close to the first mold, fourth molding parts each in ring-shaped and respectively formed around the outer peripherals of the third molding parts and second balancing rings each in ring-shaped and formed by the outer peripherals of the fourth molding parts; and the second balance ring is configured to facilitate a transition between the outer peripheral edge of the fourth molding part and the side of the second mold body close to the first mold; and
the first mold body and the second mold body are arranged correspondingly, the first molding part and the third molding part correspond to each other and are spaced apart to form a first gap, and the first gap is configured to form an optical part of the lens;
the second molded part and the fourth molded part correspond to each other and are spaced apart to form a second gap, and the second gap is configured to form a structural part of the lens; and the first balancing ring and the second balancing ring correspond to each other and are spaced apart to form a third gap, and the third gap is configured to form an auxiliary part of the lens.

2. The mold of claim 1, wherein:
the plurality of first molding parts are arranged in an array and the plurality of the third molding parts are arranged in an array.

3. The mold of claim 1, wherein:
the first gap has a thickness gradually increasing from its center toward a direction approaching the second gap, and
the third gap has a thickness gradually decreasing from a side close to the second gap to a direction away from the second gap.

4. The mold of claim 3, wherein:
a central thickness of the optical part gradually increases along a thickness of its outer edge;
a thickness of an inner edge of the structural part is equal to a thickness of an outer edge of the optical part;
a thickness of the inner edge of the structural part gradually decreases along a direction of its outer edge; and
a thickness of the auxiliary part gradually decreases from a thickness close to an outer edge of the structural part to a thickness away from the outer edge of the structural part.

5. The mold of claim 4, wherein:
the first molding part is formed by a protrusion from a side of the first mold body close to the second mold body, the second molding part is formed by a depression on one side of the first mold body close to the second mold body, and the first balancing ring is formed by a recess on one side of the first mold body close to the second mold body; and
the third molding part is formed by a side of the second mold body close to the first mold body that is recessed inwards, the fourth molding part is formed by a side of the second mold body close to the second mold body that is recessed inwards, and the second balance ring is formed by a depression on a side of the second mold body close to the first mold body, wherein a depth of the depression of the third molding part is smaller than a depth of the depression of the fourth molding part.

6. The mold of claim 1, wherein:
the first gap has a thickness gradually decreasing from its center in a direction approaching the second gap, the third gap has a thickness gradually increasing from the side close to the second gap to the side away from the second gap, and the thickness of the third gap is smaller than the thickness of the first gap.

7. The mold of claim 6, wherein:
a central thickness of the optical part gradually decreases along its outer edge, a thickness of the inner edge of the structural part is equal to the thickness of the outer edge of the optical part, a thickness of the inner edge of the structural part gradually increases along the direction of its outer edge, and a thickness of the auxiliary part gradually increases from the thickness close to the outer edge of the structural part to the thickness away from the outer edge of the structural part.

8. The mold of claim 7, wherein:
the first molding part is formed by a depression on one side of the first mold body close to the second mold body, the second molding part is formed by a protrusion of the first mold body close to the second mold body, and the first balancing ring is formed by a recess on one side of the first mold body close to the second mold body; and
the third molding part is formed by a recess on a side of the second mold body close to the first mold body, the fourth molding part is formed by a recess on a side of the second mold body close to the second mold body, and the second balancing ring extends horizontally from the side of the second mold body close to the first mold body.

9. The mold of claim 1, wherein:
a thickness of the first gap is equal to the thickness of the second gap, and a thickness of the third gap gradually decreases from a side close to the second gap to a side away from the second gap.

10. The mold of claim 9, wherein:
a central thickness of the optical part is consistent with a thickness of its outer edge; a thickness of the inner edge of the structural part is equal to a thickness of the outer edge of the optical part, a thickness of the inner edge of the structural part gradually increases along a direction of its outer edge, and a thickness of the auxiliary part gradually decreases from a thickness close to the outer edge of the structural part to a thickness away from the outer edge of the structural part.

11. The mold of claim 10, wherein:
the first molding part is formed by a protrusion from a side of the first mold body close to the second mold body, the second molding part is formed by a side of the first mold body close to the second mold body being recessed inwards, and the first balancing ring protrudes from a side of the first mold body close to the second mold body; and
the third molding part is formed by a recess on a side of the second mold body close to the first mold body, the fourth molding part is formed by a recess on a side of the second mold body close to the second mold body, and the second balancing ring is formed by a recess on a side of the second mold body close to the first mold body.

12. The mold of claim 1, wherein:
the first balancing ring and the second balancing ring jointly realize overflow or flow obstruction.

13. A method for fabricating a lens, wherein the method is implemented based on the mold according to claim 1, and the method comprises the following steps of:
S1. providing a sheet material to be processed;
S2. stacking the sheet material on an upper surface of the second mold;
S3. heating the second mold to soften the sheet material;
S4. fitting the first mold, corresponding to the second mold, on the sheet material;
S5. extruding the first mold according to a preset pressure to form a lens blank; and
S6. cutting off the lens blank formed in a portion corresponding to a third gap to obtain the finished lens.
